(19) United States
(12) Patent Application Publication
(10) Pub. No.: US 2016/0278520 A1
(43) Pub. Date: Sep. 29, 2016

(54) Funnel Support and Storage Systems

(71) Applicant: Ludwig Dawson, Castro Valley, CA (US)

(72) Inventor: Ludwig Dawson, Castro Valley, CA (US)

(21) Appl. No.: 15/081,504

(22) Filed: Mar. 25, 2016

Related U.S. Application Data
(60) Provisional application No. 62/139,615, filed on Mar. 27, 2015.

(51) Int. Cl. A47B 81/00; B67C 11/00

(52) U.S. Cl. CPC A47B 81/00; B67C 11/00

(57) ABSTRACT

The invention provides a funnel support system, wherein an exemplary embodiment is a funnel tree system comprising a base, a central trunk, and numerous branches, the branches angled upwards to receive funnels for storage and/or support. In use, the funnel tree may be placed in a bucket to contain residues from the funnels. The funnel support system is of use to those engaged in vehicle and engine mechanics, motorized vehicle repair and service shops, boat repair and service shops, airplane repair and service shops, and the like.

### RELATIONSHIP TO PRIOR APPLICATIONS

This non-provisional application claims priority to U.S. Provisional Patent Application Ser. No. 62/139,615 entitled “Funnel Support or Storage System”, filed Mar. 27, 2015, which is herein incorporated by reference in its entirety for all purposes. The present application claims priority to and the benefit of the above application 62/139,615.

### FIELD OF THE INVENTION

The invention is drawn to systems or apparati for supporting and/or storing funnels.

### BACKGROUND OF THE INVENTION

There remains many ways to improve the operational efficiency of servicing motor vehicles, boats, and the like. One problem a motor mechanic frequently encounters when servicing a motor car is locating a relatively clean funnel with which to use to transfer used oil or other vehicle fluids from the engine, transmission, or universal cylinder to a waste receptacle. Frequently the mechanic finds that another mechanic misplaced the correctly-shaped funnel, or that the funnel has been left, still covered in oil or other residue, in a jumble with other different funnels.

Dowd U.S. Pat. No. 5,381,839 discloses a liquid disburser device including a top member having an upper funnel chamber section for receiving liquid and a lower liquid discharge column leading downwardly from the upper funnel chamber section; the lower discharge column including an inner diameter of sufficiently reduced size whereby liquid enters the discharge column from the upper funnel chamber in a filling equal amount; the discharge column having a plurality of equally angularly spaced tubular members spaced in equal distance about the bottom portion of the discharge column; the tubular members extending downwardly and having respective end portions adapted to be inserted into the inlet of a liquid container for conducting equal amounts of liquid from the funnel chamber into respective containers to be filled therefrom.

U.S. Patent Application number 20070272714 (Harpenau) discloses a funnel bucket device for storing, transporting and dispensing liquids, comprised of a housing for holding a liquid, having an opening at an upper surface (the opening having the shape of a funnel), a generally concave inclined bottom surface, and having a support system to support the housing. In addition, an online blog (http://i16.photobucket.com/albums/b9/AlbertaBoy/FunnelTree.jpg) discloses a funnel tree apparatus comprising a set of tubes or pipes vertically disposed, each vertical tube or pipe having an upper aperture and connected at its base (lower aperture) to a gently sloping tube of pipe, and wherein the gently sloping tube or pipe comprises a single aperture at one end. In use, the spout of a funnel is placed into the aperture of one of the vertical tubes or pipes and the apparatus is used to drain residual fluids from the funnels into a bucket placed adjacent to the aperture of the gently sloping tube or pipe.

### SUMMARY OF THE INVENTION

The invention contemplates a system or apparatus for supporting, organizing, and storing funnels, the system comprising a first base, a first shaft, wherein the first shaft has a distal end and a proximal end, an external surface and at least one aperture located on the external surface of the first shaft between the distal end and the proximal end, and at least one second shaft, the at least one second shaft having a distal end and a proximal end, wherein the first base is shaped and adapted for receiving the proximal end of the first shaft, and wherein the at least one aperture on the external surface of the first shaft is shaped and adapted for receiving and engaging the proximal end of the at least one second shaft. In one preferred embodiment, the first shaft has a diameter greater than the diameter of the at least one second shaft. In another preferred embodiment, the system comprises a plurality of apertures on the external surface of the first shaft. In a further more preferred embodiment, the system comprises a plurality of second shafts. In one alternative embodiment, at least one second shaft has a diameter smaller than the diameter of one other second shaft. In another alternative embodiment, at least one second shaft has a length smaller than the length of one other second shaft. In another preferred embodiment, the at least one second shaft is shaped and adapted for receiving the neck of a funnel. In one more preferred embodiment, the distal end of the second shaft comprises a spout guide, the spout guide shaped and adapted to receive a spout of a funnel. In a more preferred embodiment, the spout guide is a sphere.

In another preferred embodiment, the system or apparatus further comprises an open container, the container comprising a second base, and at least one vertical wall. In a more preferred embodiment, the first base is shaped and adapted for placement in the open container. In another more preferred embodiment, the second base of the container is shaped as a circle. In an alternative more preferred embodiment, the second base of the container is shaped as a polygon. In another more preferred embodiment, the container comprises a plurality of vertical walls.

In another preferred embodiment, the system or apparatus further comprises a handle, wherein the distal end of the first shaft comprises the handle. In a more preferred embodiment, the handle is selected from the group consisting of a circular loop, an oval loop, a hook, and a grip.

In a more preferred embodiment, the system or apparatus comprises wherein an angle formed by (i) the proximal end of the at least one second shaft engaged in the aperture of the first shaft and by (ii) the first shaft is less than 90°. In another alternative embodiment the angle is less than 60°. In a further alternative embodiment, the angle is less than 30°. In another preferred alternative embodiment an angle formed by (i) the proximal end of one second shaft engaged in an aperture of the first shaft and by (ii) the first shaft is different from an angle formed by (iii) the proximal end of another second shaft engaged in an aperture of the first shaft and by (iv) the first shaft.

In another embodiment, the funnel tree system or apparatus comprises at least one label, wherein the label is located on the external surface of the first shaft, the label indicating the size of funnel suitable to be placed over the adjacent second shaft. In a more preferred embodiment, the system or apparatus comprises a plurality of labels. In an alternative embodiment, the indication of funnel suitable for placement is etched into the external surface of the first shaft. In another alternative embodiment, the indication is etched onto the surface of the second shaft.

In a one aspect, the funnel tree system or apparatus is manufactured from oil-resistant materials using at least one process selected from blow molding, die cutting, die pressing, die stamping, extrusion, vacuum infiltration, injection molding, rotational molding, thermoforming, thermoplastic molding and thermosetting. In a second aspect, the oil-resistant materials are paper or organic polymers selected from cellulosics, coated paper, nitrile resins, paper slurry, polybutylene, polyethylene, polyethylene terphthalate, polystyrene, polyvinylchloride thermoplastic resins, and thermosetting resins. In a third aspect, the manufacturing process can include pre-perforation of the apertures on the external surface of the first shaft. In a fourth aspect, the funnel tree system or apparatus is disposable or reusable.

In another embodiment, the funnel tree may comprise as many or as few second shafts as may be needed by a user. In another embodiment, the funnel tree may be shaped and sized for use in a factory location. In an alternative embodiment, the funnel tree may be shaped and sized for use in a domestic location, for example, a kitchen or the like.

The invention also provides an ornamental design for a funnel support system, the ornamental design as shown and described.

In another embodiment, the funnel support system comprises a backing plate, a plurality of second shafts, wherein each second shaft has a proximal end and a distal end, and wherein the second shaft is fixedly attached to the backing plate, wherein the angle formed by the line of the second shaft and the plane of the backing plate is between at least 5° and 85°, and wherein the distal end comprises a spout guide.

In yet another embodiment, the funnel support system comprises an alternative backing plate, wherein the alternative backing plate comprises two backing plates fixedly attached to each other at about a right angle, a plurality of second shafts, wherein each second shaft has a proximal end and a distal end, and wherein the second shaft is fixedly attached to one of the backing plates, wherein the angle formed by the line of the second shaft and the plane of the backing plate is between at least 5° and 85°, and wherein the distal end comprises a spout guide.

### DESCRIPTION OF THE DRAWINGS

FIG. 1A shows a funnel support system (“Funnel Tree”) 1 as viewed from a side; FIG. 1B shows an illustrative example of how a funnel 7 may be placed on a second shaft (or branch) 3 and spout guide 8 of the system 1; and FIGS. 1C, 1D, and 1E show three aerial views of three exemplary tiers of second shafts, showing that they may be placed in a staggered arrangement. FIG. 1A illustrates the funnel tree from a side perspective; FIG. 1 B illustrates a funnel that may be placed over a sprout guide and a part of a second shaft (branch); FIGS. 1C, 1D, and 1E, illustrate a view from above showing the relative positions of the second shafts (branches) of Tier 1, Tier 2, and Tier 3, respectively.

FIG. 2 shows another funnel support system (“Funnel Rack”) 14 as viewed from the front (FIG. 2A) and as viewed from the side (FIG. 2B). FIGS. 2A and 2B show an exemplary arrangement and placement of the second shafts 3 having a proximal end attached to the backing plate 17. Each second shaft 3 further comprises a spout guide 8 at the distal end. Note that for ease of view only a few of the second shafts and spout guides have been shown with reference lines and numbers.

FIG. 3 shows another funnel support system (“Corner Rack”) 16 as viewed from the front (FIG. 3A) and as viewed from above or below (FIG. 3B). FIGS. 3A and 3B show an exemplary arrangement and placement of the second shafts 3 having a proximal end attached to an alternative backing plate 17 wherein the alternative backing plate comprises two backing plates 18 fixed to each other at a right angle or thereabouts. Each second shaft 3 further comprises a spout guide 8 at the distal end. Note that for ease of view only a few of the second shafts and spout guides have been shown with reference lines and numbers.

### DETAILED DESCRIPTION OF THE INVENTION

### Definitions

Unless defined otherwise, all terms are understood to have the same meaning as commonly used in the art to which they pertain. In this application, the singular forms “a”, “an”, and “the” include plural references unless the context clearly dictates otherwise. It is noted that any of the embodiments disclosed herein may be used in various and any combination that can be of benefit. For the purpose of this invention, the following terms are defined below.

“Oil-resistant” refers to materials for manufacturing a funnel tree system or apparatus, such as natural or organic polymers that are resistant to alcohol, grease, heat and water including but not limited to cellulosics, foams, nitrile resins, paper slurries, thermoplastic resins and thermosetting resins including but not limited to polybutylene, polyethylene, polyethylene terephthalate, and polystyrene; and plastisols (i.e., dispersion grade polyvinylchloride resin in a plasticizer) that are used to form or coat the funnel tree.

“Operably attached” refers to any means or mechanism by which a second shaft or a base is adhered, connected, glued, sealed, thermoformed, or thermoset to any part of the first shaft, or the first shaft is attached to a base.

“Operably engaged” refers to any means by which the shaft attaches to, connects with, grips, mates with or snaps onto another shaft or a base.

### Description

The funnel tree tiers' “branches” are angled and arranged for ease of access and storage of multiple funnels of various shapes and sizes. A mechanic may simply slide a funnel “leaf” small end first onto any open tier “branch”. During the storage period, due to the angles of the tiers' “branches”, the funnels residual fluid is allowed to drain from the funnel onto the tier “branch” and then onto the shaft “trunk” then run down to the base “roots” where it remains until it becomes possible and/or necessary to properly dispose of.

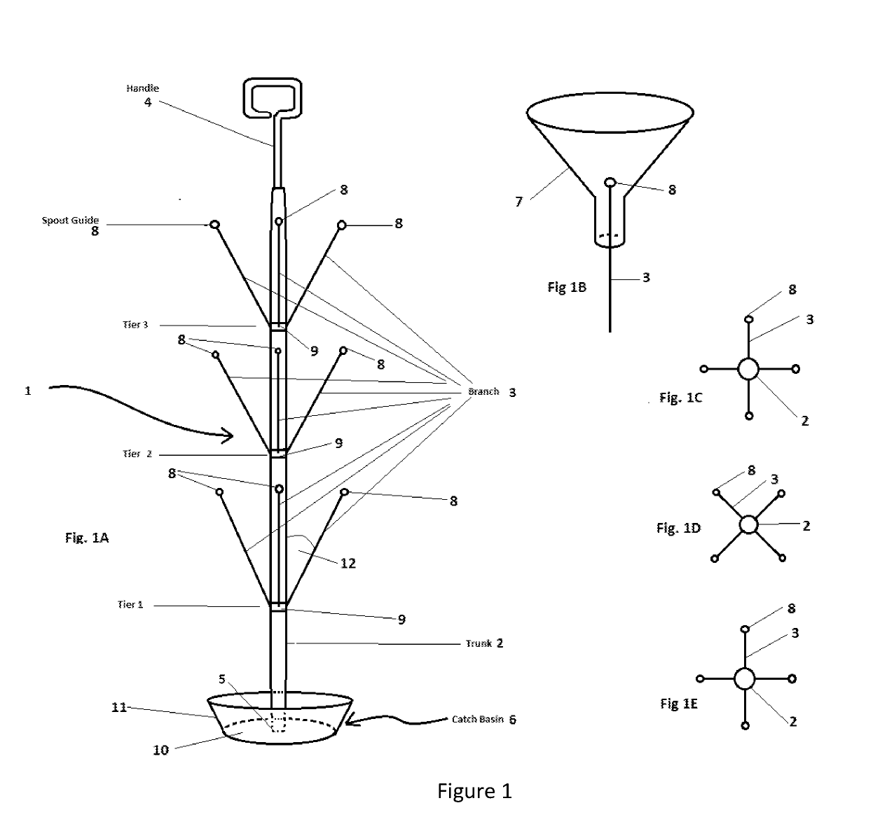

FIG. 1 shows a preferred embodiment of the funnel support system or apparatus 1 from a side perspective. As may be seen on FIG. 1A, the central (first) shaft (or “trunk”) 2 of the funnel tree has a plurality of second shafts (or “branches”) 3 affixed or attached or adhered or otherwise engaged to various locations using a collar 9 on the external surface of the first shaft 2. The system or apparatus further comprises a handle 4 affixed or attached or adhered or otherwise engaged to the distal end of the central (first) shaft 1. The system or apparatus further comprises a base 5, and FIG. 1A also illustrates that the base/first shaft/second shaft/handle unit may be placed in a receptacle, for example, a bucket or catch basin 6. The catch basin 6 comprises at least one second base 10 and at least one wall 11. The wall 11 may be vertical relative to the second base 10 and may be perpendicular or may be less than perpendicular relative to the second base 10. FIG. 1A also shows that an angle 12 may be measured between a branch 3 and the trunk 2. The angle between the branch and the trunk may be chosen and adapted for use depending upon which size and/or type of funnel is to be placed upon the branch. FIG. 1B shows how a funnel 7 may be placed upon the funnel tree system, wherein the distal end of a second shaft comprises a spout guide 8. Also shown in FIGS. 1C, 1D, and 1E are aerial views of each of tier 1, 2, and 3, respectively of second shafts, thereby illustrating how the relative placement of each tier of second shafts may be staggered, thereby allowing funnels of different size and shape to be placed upon the branches of the funnel tree system.

The width of the first shaft can have any dimension suitable for the system or apparatus itself. For example, the width of the first shaft can be 1 mm, it can be 1.5 mm, it can be 2 mm, it can be 2.5 mm, it can be 3 mm, it can be 4 mm, it can be 5 mm, it can be 6 mm, it can be 7 mm, it can be 8 mm, it can 9 mm, it can be 10 mm, it can be 11 mm, it can be 12 mm, it can be 13 mm, it can be 14 mm, it can be 15 mm, it can be 16 mm, it can be 17 mm, it can be 18 mm, it can be 19 mm, it can be 20 mm, it can be 25 mm, it can be 30 mm, or any dimension therebetween. Other larger dimensions are also contemplated and which may be used if the funnel system or apparatus is adapted for use with other proportionally larger systems, apparatus, or tools.

The width of the second shaft can have any dimension suitable for the system or apparatus itself. For example, the width of the second shaft can be 1 mm, it can be 1.5 mm, it can be 2 mm, it can be 2.5 mm, it can be 3 mm, it can be 4 mm, it can be 5 mm, it can be 6 mm, it can be 7 mm, it can be 8 mm, it can 9 mm, it can be 10 mm, it can be 11 mm, it can be 12 mm, it can be 13 mm, it can be 14 mm, it can be 15 mm, it can be 16 mm, it can be 17 mm, it can be 18 mm, it can be 19 mm, it can be 20 mm, it can be 25 mm, it can be 30 mm, or any dimension therebetween. Other larger dimensions are also contemplated and which may be used if the funnel system or apparatus is adapted for use with other proportionally larger systems, apparatus, or tools.

The height of the funnel support system can have any dimension suitable for the system or apparatus itself. For example, the height of the first shaft can be 10 cm, it can be 11 cm, it can be 12 cm, it can be 13 cm, it can be 14 cm, it can be 15 cm, it can be 16 cm, it can be 17 cm, it can be 18 cm, it can be 19 cm, it can be 20 cm, it can be 25 cm, it can be 30 cm, it can be 35 cm, it can be 40 cm, it can be 45 cm, it can be 50 cm, it can be 60 cm, it can be 70 cm, it can be 80 cm, it can be 90 cm, it can be 1 m, it can be 1,5 m, or any dimension therebetween. Other larger dimensions are also contemplated and which may be used if the funnel system or apparatus is adapted for use with other proportionally larger systems, apparatus, or tools.

The width of the funnel support system can have any dimension suitable for the system or apparatus itself. For example, the length of the second shaft can be 5 cm, it can be 6 cm, it can be 7 cm, it can be 8 cm, it can be 9 cm, it can be 10 cm, it can be 11 cm, it can be 12 cm, it can be 13 cm, it can be 14 cm, it can be 15 cm, it can be 16 cm, it can be 17 cm, it can be 18 cm, it can be 19 cm, it can be 20 cm, it can be 25 cm, it can be 30 cm, it can be 35 cm, it can be 40 cm, it can be 45 cm, it can be 50 cm, it can be 60 cm, it can be 70 cm, it can be 80 cm, it can be 90 cm, it can be 1 m, it can be 1,5 m, or any dimension therebetween. Other larger dimensions are also contemplated and which may be used if the funnel system or apparatus is adapted for use with other proportionally larger systems, apparatus, or tools.

The novelty of the funnel tree disclosed herein may be appreciated by those in the relevant art; the funnel tree component can be manufactured as one piece and without using additional tools to create holes or apertures within the trunk.

It is also contemplated that the second shaft can be manufactured separately from the first shaft and operably attached to it.

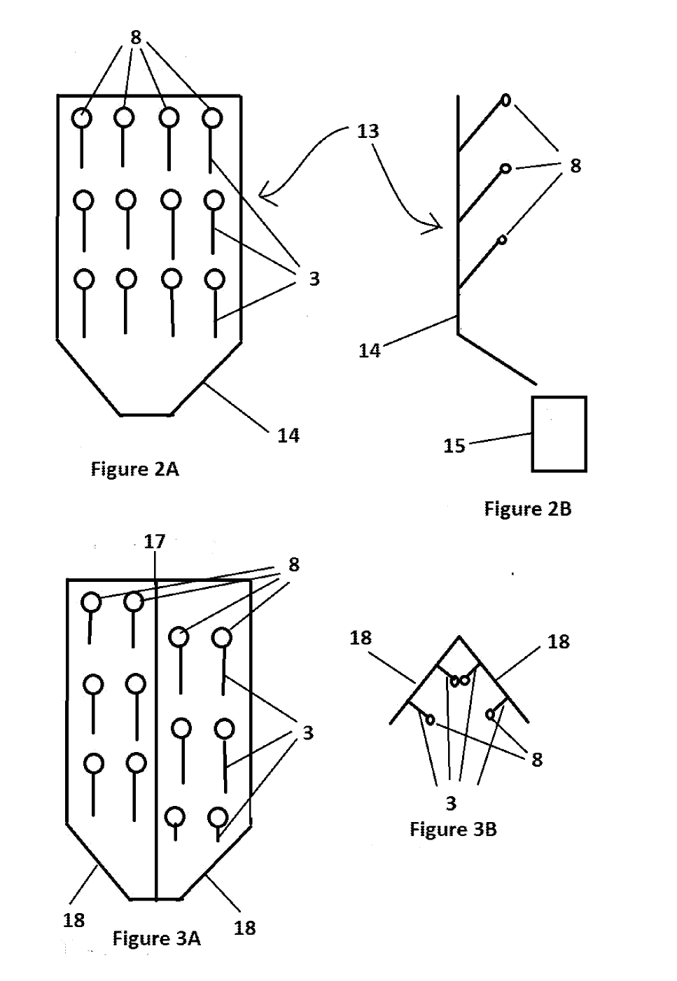

The invention also contemplates a funnel support system as illustrated in FIGS. 2A and 2B which show the funnel support system (“Funnel Rack”) 13 as viewed from the front (FIG. 2A) and as viewed from the side (FIG. 2B). The structural elements of the Funnel Rack are essentially identical to those elements as disclosed for the Funnel Tree with the exception that the plurality of second shafts, each comprising a proximal end and a distal end, wherein the proximal end is secured to a backing plate 14 and the distal end comprises a funnel guide 8. The Funnel Rack may be mounted on a wall or other upright surface and has a similar use to that of the Funnel Tree disclosed above. The advantage of the Funnel Rack is that it may be placed by a user in a convenient location in a workshop and it does not take up the floor space that would otherwise be used by the Funnel Tree. The FIGS. 2A and 2B show an exemplary arrangement and placement of the second shafts 3 having a proximal end attached to a backing plate 14, also shown is an optional oil or fluid catching basin (or drip bucket) 15. Each second shaft 3 further comprises a spout guide 8 at the distal end. Note that for ease of view only a few of the second shafts and spout guides have been shown with reference lines and numbers.

The invention also contemplates a funnel support system as illustrated in FIGS. 3A and 3B which show the funnel support system (“Corner Rack”) 16 as viewed from the front (FIG. 3A) and as viewed from above or below (FIG. 3B). The structural elements of the Corner Rack are essentially identical to those elements as disclosed for the Funnel Rack with the exception that an alternative backing plate 17 comprises two backing plates 18 fixedly attached to each other perpendicular to each or thereabouts. The Corner Rack may be mounted at the junction of two walls or other upright surfaces and has a similar use to that of the Funnel Rack disclosed above. The advantage of the Corner Rack is that it may be placed by a user in a convenient location in a corner of a workshop that would otherwise not be used and it does not take up the wall space that would otherwise be used by the Funnel Rack. FIGS. 3A and 23B show an exemplary arrangement and placement of the second shafts 3 having a proximal end attached to an alternative backing plate 17 wherein the alternative backing plate comprises two backing plates 18 fixed to each other at a right angle or thereabouts. Each second shaft 3 further comprises a spout guide 8 at the distal end. Note that for ease of view only a few of the second shafts and spout guides have been shown with reference lines and numbers.

Funnel support systems in various sizes can be color-coded and/or labeled by the manufacturer or at the factory where they are made.

The funnel support system can be manufactured using a variety of materials. In one embodiment the material can be a metal selected from the group consisting of nickel, nickel-titanium alloy, brass, aluminum, chromel, stainless steel, zinc, copper, gold, platinum, silver, and titanium. In an alternative embodiment the funnel support system comprises a material selected from the group consisting of barium sulfate, titanium oxide, silicone, polyurethane, polyethylene, acrylonitrile butadiene stryrene, polycarbonate, polypropylene, styrene, polyamide, polyimide, PEEK, PEBAX, polyester, polyvinyl chloride (PVC), uPVC, CPVC, ethylene vinyl acetate (EVA), elastomer, polyolefin, fluoropolymers, and co-polymers thereof. In another embodiment, the funnel support system can be manufactured using a combination of a metal and a non-metal material.

The funnel support system can also comprise a coating, the coating selected from the group consisting of a zinc-aluminum-magnesium coating, a thermal diffusion galvanized coating, a PERMA-GREEN coating, a powder coating, an electrocoating (E-coat or Electrophoretic deposition coating), a paint coating, an epoxy coating, a polyvinyl chloride (PVC) coating, a trivalent chromium coating, a hexavalent chromium coating, a zinc coating, and a copper coating.

The funnel support system may be manufactured using means know to those of skill in the art. Such means include, but are not limited to die stamping or pressing, vacuum infiltration, injection molding, and the like. In another embodiment, the funnel support system may be manufactured using a three-dimensional (3-D) printer, wherein the dimensions and shape of the funnel support system are entered into a software program, such as the computer-aided design (CAD) software, and the CAD software is used to control the 3-D printing process.

### Utility

Various modifications and variations of the compartmented lid, materials and methods for manufacturing and filling it will be apparent to those skilled in the art without departing from the scope and spirit of the invention. Although the invention has been described in connection with specific embodiments, it should be understood that the invention as claimed should not be unduly limited to these specific embodiments. Indeed, various modifications of the described material and methods for carrying out the invention that are known to those persons skilled in the art or related fields are intended to be within the scope of the following claims.

I claim:

1. A system 1 for supporting and storing funnels, the system comprising a first base 5, a first shaft 2, wherein the first shaft 2 has a distal end and a proximal end, an external surface and at least one collar 9 comprising an aperture located on the external surface of the first shaft 2 between the distal end and the proximal end, and at least one second shaft 3, the at least one second shaft 3 having a distal end and a proximal end, wherein the first base 5 is shaped and adapted for receiving the proximal end of the first shaft 2, and wherein the at least one collar 9 comprising at least one aperture on the external surface of the first shaft 2 is shaped and adapted for receiving and engaging the proximal end of the at least one second shaft 3.

2. The system of claim 1, wherein the first shaft 2 has a diameter greater than the diameter of the at least one second shaft 3.

3. The system of claim 1, wherein the system 1 comprises a plurality of collars 9 comprising a plurality of apertures on the external surface of the first shaft 2.

4. The system of claim 3, wherein the system 1 comprises a plurality of second shafts 3.

5. The system of claim 4, wherein one second shaft 3 has a diameter smaller than the diameter of one other second shaft 3.

6. The system of claim 4, wherein one second shaft 3 has a length smaller than the length of one other second shaft 3.

7. The system of claim 1, wherein the at least one second shaft 3 is shaped and adapted for receiving the neck of a funnel 7.

8. The system of claim 1, further comprising an open container 6, the container comprising a second base 10, and at least one vertical wall 11.

9. The system of claim 1, wherein the first base 5 is shaped and adapted for placement in the second base 10 of the open container 6.

10. The system of claim 8, wherein the second base of the container 10 is shaped as a circle.

11. The system of claim 8, wherein the second base of the container 10 is shaped as a polygon.

12. The system of claim 8, wherein the container comprises a plurality of vertical walls 11.

13. The system of claim 1, wherein the distal end of the first shaft 2 further comprises a handle 4.

14. The system of claim 13, wherein the handle 4 is selected from the group consisting of a circular loop, an oval loop, a hook, and a grip.

15. The system of claim 1, wherein an angle 12 formed by (i) the proximal end of the at least one second shaft 3 engaged in the aperture in the collar 9 of the first shaft 2 and by (ii) the first shaft 2 is less than 90°.

16. The system of claim 15, wherein the angle 12 is less than 60°.

17. The system of claim 15, wherein the angle 12 is less than 30°.

18. The system of claim 4, wherein an angle 12 formed by (i) the proximal end of one second shaft 3 engaged in an aperture in the collar 9 of the first shaft 2 and by (ii) the first shaft 2 is different from an angle 12 formed by (iii) the proximal end of another second shaft 3 engaged in an aperture in the collar 9 of the first shaft and by (iv) the first shaft 2.

19. The system of claim 1, wherein the distal end of the second shaft 3 further comprises a spout guide 8.

20. An ornamental design for a funnel support system, as shown and described.
